(19) United States
(12) Patent Application Publication
(10) Pub. No.: US 2006/0224426 A1
(43) Pub. Date: Oct. 5, 2006

(54) Transportation planning with system assisted exception resolution

(75) Inventors: Roger Johannes Anna Goossens, Belmont, CA (US); Roy Isaac Peterkofsky, San Francisco, CA (US); Hema Budaraju, Fremont, CA (US); Atul Kumar Srivastav, Hyderabad (IN); Rekha Rani Argula, Hyderabad (IN); Vijay Pillarisetti, Fremont, CA (US); Jin Huang, Foster City, CA (US)

Correspondence Address: MCDONALD HOPKINS CO., LPA, 600 SUPERIOR AVE., E., SUITE 2100, CLEVELAND, OH, 44114, US

(73) Assignee: Oracle International Corporation, Redwood Shores, CA (US)

(21) Appl. No.: 11/093,830

(22) Filed: Mar. 30, 2005

(51) Int. Cl. G06F 9/46

(52) U.S. Cl. 705/8

(57) ABSTRACT

Systems, methodologies, media, and other embodiments associated with manipulating a transportation plan based on system assisted exception resolutions are described. One exemplary computer-implemented method embodiment includes accessing transportation orders and an actionable plan of loads. The method may also include identifying planning exceptions, identifying candidate planning actions for resolving the exceptions, and providing data concerning the impact that resolving the exception using the candidate planning action will have.

### BACKGROUND

The input to a transportation planning system may be, for example, a set of transportation orders. A transportation order may describe parameters associated with a commodity to be delivered. A data structure associated with an order may include data like a commodity to be delivered, an amount of the commodity to be delivered, a request date, an earliest acceptable date, a latest acceptable date, a scheduled ship date, a scheduled arrival date, a promised delivery date, and so on. The output of a transportation planning system may be, for example, a transportation plan that includes an actionable plan of loads that satisfies some (hopefully all) of the transportation orders. The actionable plan of loads may include, for example, a set of consolidated shipments along with specific route, mode (e.g., parcel, less-than-truckload (LTL), truckload (TL)), carrier, service, vehicle selection, and so on.

Transportation planning systems may employ multi-criteria, constraint-based, decision-making to facilitate minimizing transportation costs by examining orders and producing the actionable plan of loads. The plan may detail consolidated loads and may identify shipping attributes associated with satisfying orders like carriage modes, carriers, routes, vehicles, and so on. Transportation planning systems may also be configured to facilitate improving planning considerations like on-time delivery, customer satisfaction, routing guide compliance, preferred carrier usage, volume-based pricing usage, and so on. Minimizing transportation costs while improving planning considerations like on-time delivery may produce conflicting and/or competing goals. Thus, transportation planning systems may be configured to selectively make trade-offs between, for example, transportation cost and plan quality to maximize, for example, an overall utility. In this manner, transportation planning systems may violate business rules and/or constraints in order to achieve either additional cost savings or to respect other contradicting rules and/or constraints.

Transportation planning systems may need to perform within limits associated with factors like planning horizons, plan scope, available computing power and so on. Additionally, transportation planning systems may have to consider configurable constraints associated with executing a plan. For example, a transportation planning system may consider factors like, which constraints and/or penalties are to be applied when optimizing a plan, the order in which some constraints can be relaxed and/or violated, which costs are to be considered when planning and optimizing, and so on. To maximize overall utility, a trade off may be made that leads to a rule being violated and thus an exception like a transportation planning exception may be raised.

An exception alert may inform a planner that there may be a potential problem or opportunity associated with the transportation planning output. For example, an exception may indicate that an order has not been satisfied according to desired parameters. In some examples, an exception may indicate that a planner should consider taking corrective action after a plan is produced because no plans have been made for some transportation order(s). For example, a system may identify an unplanned order as an exception and then a planner may assign a mode, carrier, service, and so on, to the unplanned order. A conventional system may identify exceptions (e.g., highlight certain plan elements or unplanned orders) but may provide no guidance concerning resolving the exceptions. Thus, a planner may be required to spend excessive time determining how to resolve an exception and what effects that resolving will have. Also, the decisions made by the planner about how to resolve the exceptions in the absence of automated decision support may have a negative impact on the overall quality of the plan since the planner may not be able to consider and/or incorporate the many factors that influence plan quality.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example computer-implemented method associated with manipulating a transportation plan based, at least in part, on a computer generated solution to a computer identified planning exception.

FIG. 2 illustrates an example method associated with transportation planning and system assisted exception resolution.

FIG. 3 illustrates an example system associated with system assisted transportation planning exception resolution.

FIG. 4 illustrates another example system associated with system assisted transportation planning exception resolution.

FIG. 5 illustrates an example computing environment in which example systems and methods illustrated herein can operate.

FIG. 6 illustrates an example method associated with a graphical user interface.

FIG. 7 is an example screen shot associated with configuring how constraints are to be considered by an automated planning engine.

FIG. 8 is an example screen shot from a computer assisted exception resolution tool.

FIG. 9 is an example screen shot from a computer assisted exception resolution tool.

FIG. 10 is an example screen shot from a computer assisted exception resolution tool.

### DETAILED DESCRIPTION

Example systems, methods, media, and other embodiments described herein relate to system assisted transportation planning exception resolution. Example systems and methods may facilitate interacting on a more cost effective basis with carriers like parcel carriers (e.g., UPS), less than truckload (LTL) carriers, truckload (TL) carriers and so on. In one example, computer-based systems and methods facilitate identifying opportunities to eliminate an exception produced by a transportation planning system. The example systems and methods may generate a candidate solution, evaluate the candidate solution for cost impact and/or constraint or rule violations, and facilitate taking an automated action to resolve the exception using the candidate solution.

A transportation planning exception may occur when conforming to a rule(s) has caused a transportation planning system to produce a sub-optimal solution and/or to violate a different rule. For example, a certain commodity (e.g., hazardous chemical) may be constrained not to travel by air. However, a delivery deadline may have been set that can only be satisfied by air transportation. Thus, a planner may need to contract with a specialized air carrier, relax the delivery deadline, and so on. In either case, a rule will be broken. Example systems and methods may point out possible solutions, the costs and benefits of each solution, and what rule(s) (if any) would be broken by each solution.

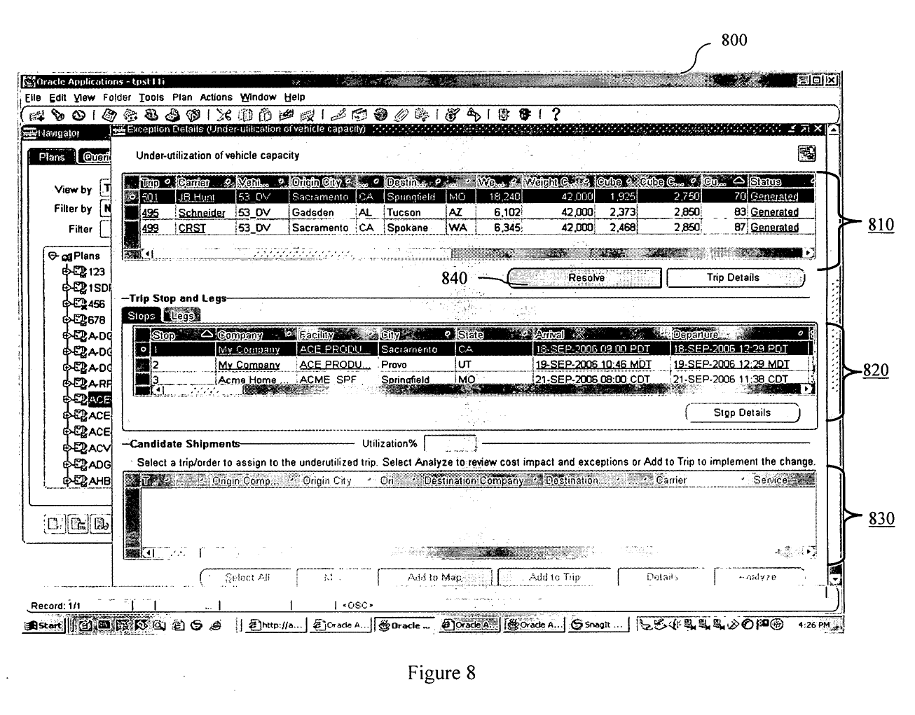

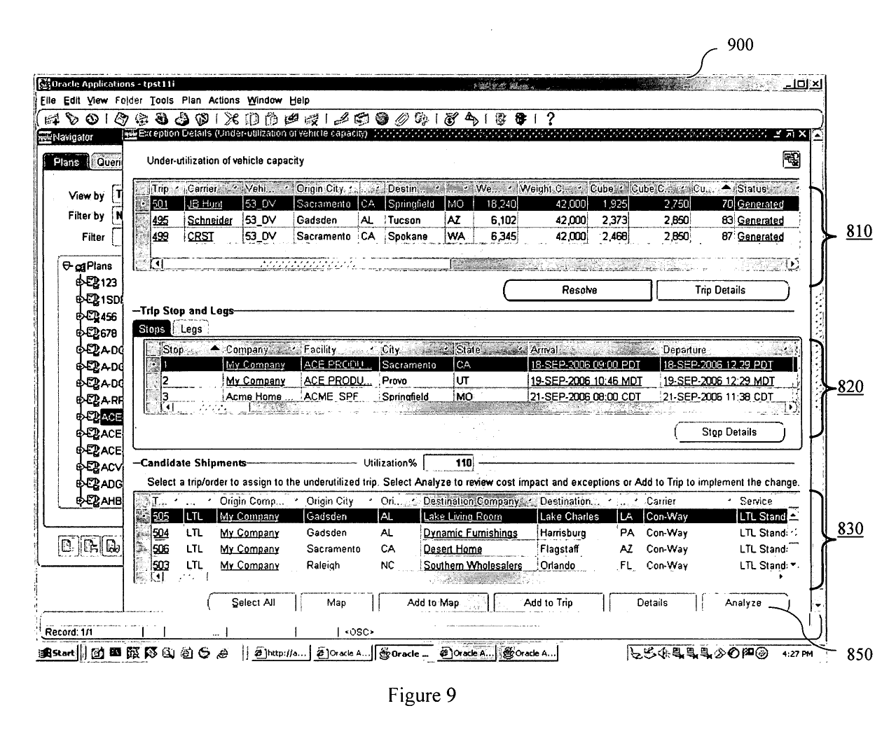

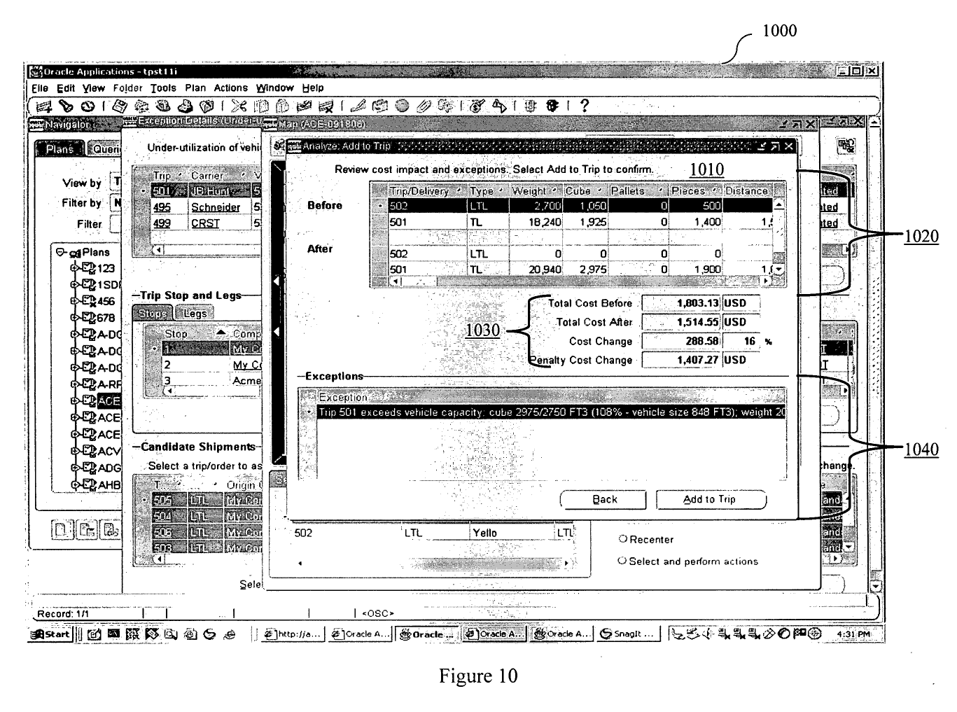

Consider an example where a plan output (e.g., transportation plan) may include some truckload trips that are not filled to target capacity utilization. For example, screen shot 800 (FIG. 8) lists trips 501, 495, and 499 as under-utilizing a truck capacity. The plan output may also include other shipments assigned to less efficient modes of transport (e.g., LTL and parcel) and/or shipments that are unassigned to a mode of transportation. These may be considered candidates to add to an underutilized truckload in order to increase its efficiency. For example, screen shot 900 (FIG. 9) lists shipments 505, 504, 506, and 503 in region 830 as being available to assign to trip 501. A planning system may have considered adding an LTL, parcel, and/or unassigned shipment(s) to an under-utilized truck to make it more full, but may have been prevented from doing so because a constraint (e.g., do not ship commodity X on truck type Y) would have been violated. Typically, the processing spent considering the addition would be wasted and a planner would be unaware of the potential addition without an exhaustive, unassisted search through the atomic plan elements. Example systems may present a planner with the potential addition, identify what constraint(s) would be violated by the addition, and compute and provide a real monetary cost and/or a penalty cost (utility function) associated with violating the constraint. For example, after selecting button 850 a user may be presented with screen shot 1000 (FIG. 10), which illustrates in region 1030 costs before and after shipment 502 is added to trip 501. Furthermore, example systems may compute, provide, and compare an overall utility achieved by both violating and not violating the constraint. Thus, a planner may decide to violate the constraint to facilitate maximizing a utility, minimizing an overall cost, and so on.

In one example, a user may be presented with a set of under-utilized trucks in a display like that in region 810 in screen shot 800. The user could also be presented with a set of candidate LTL, parcel, and/or unassigned shipments that could be allocated to the truck to improve its utilization. This data might be displayed in a region like area 830 in screen shot 900. The user may also be presented, in an area like region 1030 of screen shot 1000, with the cost impact of adding an LTL, parcel, and/or unassigned shipment to the under-utilized truck, alone and/or in combination. Additionally, the user may be presented with the cost impact, in real money or in penalty (utility) cost, associated with making the addition. Furthermore, the user may be presented, in an area like region 1040 in screen shot 1000, with other exceptions that may be generated if the addition is made.

Consider an illustrative daily transportation plan that includes 300 multi-stop truckloads. If 5% of the truckloads are under-utilized, then a planner would be faced with improving the capacity of 15 truckloads. On average, identifying LTL, parcel, and unassigned shipments and assessing the impact of adding identified LTL, parcel, and/or unassigned shipments to a trip may take more than one hour per truckload. In the example, this could require over fifteen hours just to resolve this one type of exception. A transportation plan may also include other types of exceptions. Thus, in conventional systems, the time spent in resolving exceptions may exceed the time initially gained by automating transportation planning. Given a certain daily planning frequency, the amount of time required to address exceptions may exceed the time available to work on the plan every day. Thus, the alternative to resolving exceptions with automated decision support is likely to be not resolving them at all.

Example systems and methods facilitate resolving issues with individual problem orders or loads without impacting other orders or loads. For example, 285 out of 300 truckloads may meet desired utilization parameters while 15 do not. Example systems and methods facilitate identifying actions that can be taken with respect to those 15 truckloads while leaving the other 285 alone. This may lead to a globally good plan with some locally sub-optional elements. However, these concessions may be required because it may be unfeasible and/or unwise to rework an entire plan just because 15 truckloads are troublesome. For example, some of the 285 trips may have been communicated to carriers or may even be in transit and thus would be unwise to replan. Also, some well-utilized trips may be the result of having already addressed and resolved other underutilized vehicle exceptions. A complete automated plan recalculation may result in the loss of these fully-utilized trucks, as they were not built by the original automated planning run in the first place. Consequently, there may be no reason to expect that a subsequent automatically generated plan would include the lost well-utilized loads.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity like hardware, firmware, software, software in execution, and/or a combination thereof. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer communication”, as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, semiconductor memories, dynamic memory and the like. Transmission media may include coaxial cables, copper wire, fiber optic cables, and the like. Transmission media can also take the form of electromagnetic radiation like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM (random access memory), a ROM (read only memory), an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), an analog circuit, a digital circuit, a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled. and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

Elements illustrated in the flow diagrams denote “processing blocks” that may be implemented in logic. In one example, the processing blocks may represent executable instructions that cause a computer, processor, and/or logic device to respond, to perform an action(s), to change states, and/or to make decisions. Thus, the described methodologies can be implemented as processor executable instructions and/or operations provided by a computer-readable medium. In another example, the processing blocks may represent functions and/or actions performed by functionally equivalent circuits such as an analog circuit, a digital signal processor circuit, an application specific integrated circuit (ASIC), or other logic device.

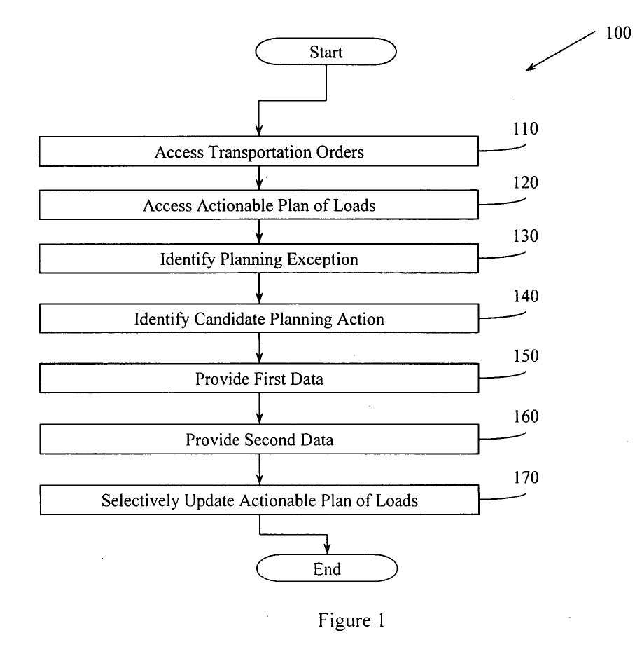

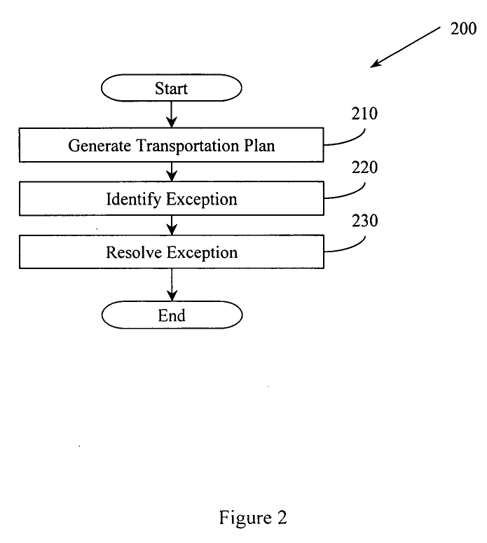

The flow diagrams of FIGS. 1 and 2 are not intended to limit the implementation of the described examples. Rather, the diagrams illustrate functional information one skilled in the art could use to design/fabricate circuits, generate software, or use a combination of hardware and software to perform the illustrated processing. It will be appreciated that electronic and software applications may involve dynamic and flexible processes and thus blocks may be performed concurrently, substantially in parallel, and/or at substantially different points in time.

FIG. 1 illustrates an example computer-implemented method 100 associated with manipulating a transportation plan based, at least in part, on computer generated solutions to computer identified transportation planning exceptions. As used herein, transportation planning refers to computer-based determining of how to interact with carriers who will be tasked with shipping items using vehicles like trucks. Transportation planning may include planning actions and execution actions. Transportation planning may be engaged in by entities that interact with carriers. While vehicles like trucks are described, it is to be appreciated that example systems and methods may facilitate planning for interacting with carriers that use other vehicles like trains, planes, and so on. Also, in some examples, “carriers” may include not only external transportation providers but also equipment owned, managed, or operated by the planning organization, and/or by other units of the same corporate, governmental, or other entity.

Method 100 may include, at 110, accessing a set of transportation orders. In one example, a transportation order may include date including, but not limited to, a commodity identifying data, an amount data, a request date data, an earliest acceptable date data, a latest acceptable date data, a scheduled ship date data, a scheduled arrival date data, and a promised delivery date data. Thus, an order may describe something to be delivered and details associated with the delivering. The orders may be stored, for example, on a data store, may be received via a computer communication, may be input to the method, and so on.

Method 100 may also include, at 120, accessing an actionable plan of loads. In one example, a load may be described by data including, but not limited to, a route data, a mode data, a carrier data, a service data, a schedule data, and a vehicle data. Thus, a load may describe details about a plan for delivering something. The loads may be stored, for example, in a memory, may be read from a file, may be downloaded from a server, and so on. How loads are determined may depend, at least in part, on trade-offs between cost and service levels in light of various constraints and related penalty costs. As described above, minimizing cost and increasing service levels (e.g., on-time delivery) may be two objectives for a transportation planning system. However, increasing service levels may increase costs, while decreasing costs may decrease service levels. Thus, to balance these potentially conflicting objectives, a planning system may be configurable with respect to selectively violating constraints. For example, constraints like vehicle capacity, vehicle availability, earliest delivery time, latest delivery time, and so on, may be identified as constraints that can be violated subject, for example, to a penalty cost. A penalty cost may represent, for example, a notional monetary cost associated with a constraint violation of a given magnitude.

By way of illustration, consider a shipment that is to be delivered within 3 days. Delivering this shipment on time may require sending it using a time-definite parcel service at a cost of $500. However, if the shipment can be late then it may be sent by a truckload carrier at a cost of $300. If a planner has determined that delivery time constraints can be violated at a penalty of $100 per day, then different options become possible. For example, a first option may involve sending the shipment on time using a parcel carrier at a cost of $500 while a second option may involve sending the shipment one day late via a truckload carrier. In the second option, the total cost may be computed as the sum of the actual cost plus a penalty cost (e.g., $300+$100=$400).

Example transportation planning systems may select the second option and present the planner with data identifying what constraint is being violated (late delivery), the penalty cost ($100) and the option that would not violate the exception. Note that in a penalty-based approach, a constraint may be converted to an element of a cost function. Thus, the planning system may be configured to pick the optimal total cost solution.

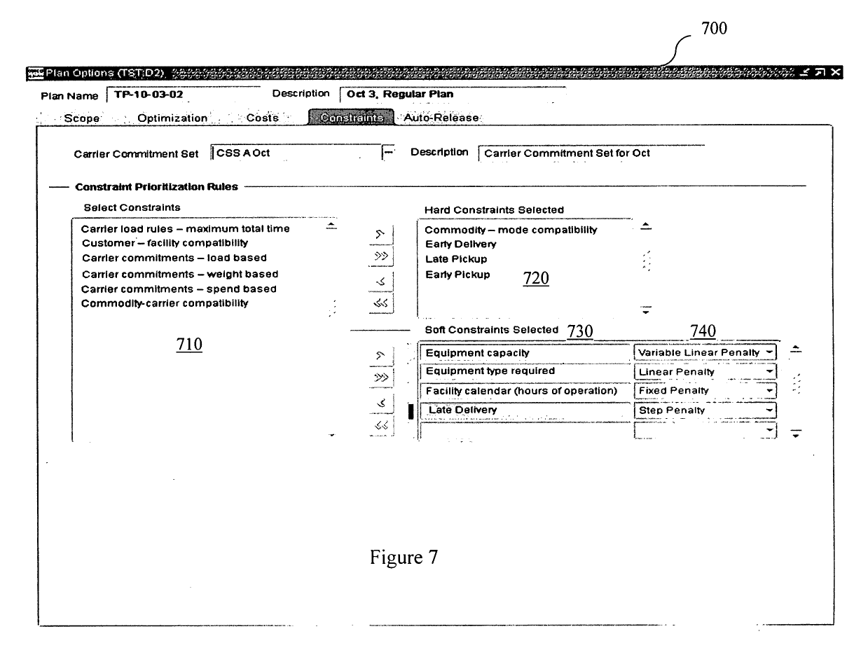

Method 100 may also include, at 130, identifying a planning exception related to the transportation plan. Identifying a planning exception may include, for example, identifying an unassigned order, identifying a load that violates a constraint, and so on. Example transportation planning methods may be configured to handle constraints in different ways and thus may produce exceptions in different ways. For example, a method may be configured to ignore a constraint, to treat the constraint as a hard constraint that may never be violated, to treat the constraint as a soft constraint that incurs a penalty for being violated, and so on. Screen shot 700 (FIG. 7) illustrates an example display that facilitates this type of configuring. Region 710 illustrates constraints still available to be configured. Region 720 illustrates constraints that have been configured as hard constraints while region 730 illustrates constraints that have been configured as soft constraints. For the soft constraints, area 740 facilitates establishing and/or manipulating a penalty cost function. Additionally, a transportation planning method may be configured to violate constraints in a pre-determined order.

Constraints may concern different items and/or groups of items like carrier load rules, carrier rules, compatibility rules, ship set rules, arrival set rules, carrier service dimension rules, late delivery rules, early delivery rules, late pick-up rules, early pick-up rules, effective vehicle capacity rules, carrier standing appointment rules, facility receiving calendar rules, facility receiving hour of operation rules, facility shipping calendar rules, facility shipping hour of operation rules, carrier commitment rules, vehicle availability rules, facility dock availability rules, facility handling capacity rules, and so on. Carrier load rules may cover, for example, maximum and/or minimum driving times, on-duty times, and so on. In one example, constraints may be configurable with respect to properties including, but not limited to, a threshold level, a major violation level, a minor violation level, and a penalty cost. It is to be appreciated that example transportation planning systems and methods may include a planning component and an exception component. Thus, it is to be appreciated that instructing the planning component how to treat constraints and instructing the exception system how to deal with corresponding exceptions may be independent functions. For example, it may be possible to configure a planning engine to ignore constraint X but to configure an exception engine to report violations of constraint X, which may occur since the planning engine is ignoring it. In fact, it is a common practice in some planning environments to run unconstrained plans and to use the resulting violations (e.g., exceptions) as starting points for problem solving.

Method 100 may also include, at 140, automatically identifying a candidate planning action for resolving the planning exception. Identifying a candidate planning action may include, for example, identifying order and/or load data to change to resolve the exception. The data may include, for example, an amount data, a scheduled ship date data, a scheduled arrival date data, a route data, a mode data, a carrier data, a service data, a vehicle data and the like. In another example, identifying a candidate planning action may include determining a constraint to violate based, at least in part, on a rule concerning the order in which constraints are to be violated. For example, a screen like screen shot 700 may facilitate arranging constraints with respect to violation order.

Method 100 may also include, at 150, providing a first data concerning an impact on a transportation plan associated with resolving the planning exception using the candidate planning action. In one example, the first data may identify a net change in a cost of the transportation plan attributable to resolving the planning exception using the candidate planning action. In another example, the first data may identify a net change in a utility of the transportation plan attributable to resolving the planning exception using the candidate planning action. Providing the data may include, for example, displaying the data on a computer monitor, transmitting the data to a logic, inputting the data to a process, and so on. While the first data is described in the context of the transportation plan, in some examples the first data may concern a single load, a single order, a group of loads, a group of orders, and so on.

Method 100 may also include, at 160, providing a second data concerning a constraint that would be violated if the planning exception is resolved using the candidate planning action. Providing the data may include, for example, presenting the data on a screen, storing the data in a memory, writing the data to a data store, and so on.

Method 100 may also include, at 170, selectively updating the actionable plan of loads based, at least in part, on the candidate planning action, the first data, and the second data. In one example, the candidate planning action may automatically be taken to manipulate the actionable plan of loads upon determining that the candidate planning action will reduce the cost of the transportation plan. In another example, the candidate planning action may be taken to manipulate the actionable plan of loads upon receiving a user input.

By way of illustration, a planner may know that while in general commodity X (e.g., plywood) should not be sent on truck type Y (e.g., cattle truck), in this case the constraint may be violated because the cattle truck is loaded with hay rather than cattle. Therefore, an experienced planner with specific information may decide to relax a constraint and thus resolve an under-utilized vehicle exception by making an addition, where information concerning the exception and the effects of its resolution are provided by example systems and methods.

While FIG. 1 illustrates various actions occurring in serial, it is to be appreciated that various actions illustrated in FIG. 1 could occur substantially in parallel. By way of illustration, a first process could access transportation orders and an actionable plan of loads, a second process could identify a planning exception, and a third process could automatically identify a candidate planning action for resolving the planning exception. A fourth process could provide data concerning the impact on the transportation plan if the candidate planning action is implemented while a fifth process could provide data concerning a constraint(s) that would be violated if the candidate planning action is illustrated. While five processes are described, it is to be appreciated that a greater and/or lesser number of processes could be employed and that lightweight processes, regular processes, threads, and other approaches could be employed.

In one example, methodologies may be implemented as processor executable instructions and/or operations stored on a computer-readable medium. Thus, in one example, a computer-readable medium may store processor executable instructions operable to perform a method for manipulating a transportation plan. The method may include accessing a set of transportation orders, accessing an actionable plan of loads, identifying a planning exception related to the transportation plan, automatically identifying a candidate planning action for resolving the planning exception, providing a first data concerning an impact on a transportation plan associated with resolving the planning exception using the candidate planning action, providing a second data concerning a constraint that would be violated if the planning exception is resolved using the candidate planning action, and selectively updating the actionable plan of loads based, at least in part, on the candidate planning action, the first data, and the second data.

While the above method is described being stored on a computer-readable medium, it is to be appreciated that other example methods described herein can also be stored on a computer-readable medium.

FIG. 2 illustrates an example method 200 associated with transportation planning and system assisted exception resolution. Method 200 may include, at 210, generating a transportation plan. The transportation plan may include, for example, a set of loads that satisfy orders for the shipping of various items according to various rules and/or constraints in a model.

Method 200 may also include, at 220, identifying exceptions in the transportation plan. For example, the plan generated at 210 may include loads that under-utilize a truck, that will be delivered too early, that will be shipped by a less preferred carrier, and so on. The exceptions may be automatically identified by a computer process.

Method 200 may also include, at 220, resolving exceptions by manipulating the transportation plan. Resolving the exceptions may include, for example, allowing a constraint to be relaxed, canceling an order, and so on. In one example, resolving the exceptions may include taking actions that are determined by a computer implemented process to mitigate the effects of the exception.

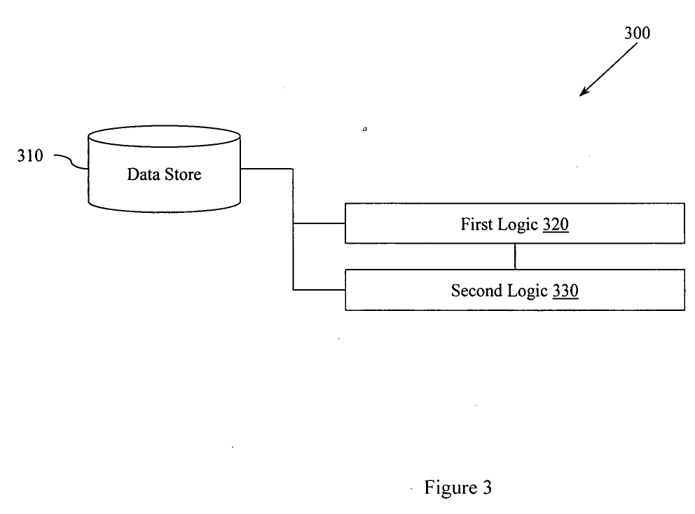

FIG. 3 illustrates an example system 300 that is configured to manipulate a transportation plan. System 300 may include a data store 310 configured to store data concerning items like a transportation planning model, a transportation plan, and a set of orders. A transportation planning model may include, for example, data concerning routes, carriers, vehicles, constraints, preferences, rules, rates, facilities, a transportation network over which the vehicles will travel, and so on. A route may describe, for example, a set of roads to be traversed by a vehicle. A carrier may describe, for example, a trucking company that provides the vehicle for a load. A constraint may describe, for example, commodities that are not allowed to travel together, commodities that must be carried by certain types of vehicles, commodities that may not traverse certain roads, and so on. A preference may describe, for example, a relationship between a preferred carrier and a commodity, a relationship between a preferred carrier and a route, a relationship between a preferred carrier and a region, a relationship between sets of orders, and so on. A rule may describe, for example, a maximum weight for a vehicle, a maximum number of hours per day of service for a driver, a maximum volume for a vehicle, and so on. A rate may describe, for example, how much is charged to carry a certain amount of a commodity by a certain mode (e.g., package, LTL, TL) in a certain period of time. A facility may describe, for example, the facility location, the facility operation hours, the facility capacity, and so on. The transportation network data may describe, for example, paths vehicles can traverse, transit times over those paths, costs associated with traversing the path, commodity restrictions for a path, and so on. While example constraints, preferences, rules, rates, and so on are described, it is to be appreciated that other examples may be possible.

A transportation planning system may have configurable optimization parameters like target truckload utilization percentages, minimum truckload utilization percentages, maximum deadhead distance requirements, and so on. Thus, information concerning these parameters may be stored, for example, in the transportation planning model stored in data store 310. Similarly, a transportation planning system may be configurable with respect to how decisions are made concerning, for example, consolidation, routing, carrier selection, and so on. Data concerning how these decisions are to be made may also be stored in data store 310. The decision making may be made in light of constraints that may also be stored, for example, in the transportation planning model in data store 310. The constraints may concern, for example, carrier load rules like a maximum number of stops, a maximum total distance, a maximum total time, a maximum total distance in twenty four hours, a minimum layover time, a maximum driving time in twenty four hours, a maximum on-duty time in twenty four hours, and so on. The constraints may also concern, for example, compatibilities between customers, facilities, suppliers, modes, carriers, vehicles, items, and so on. The constraints may also concern, for example, timing issues like late delivery, early delivery, late pick-up, early pick-up, facility operating hours, and so on. The constraints may also concern, for example, carrier commitments like load, weight, spending limits, and so on. While several types of constraints have been described, it is to be appreciated that other types of constraints may be employed.

System 300 may also include a first logic 320 that is configured to identify a planning exception. In one example, the planning exception may be related to an order in the set of orders. In another example, the planning exception may, additionally and/or alternatively, be related to a load in the set of loads. In one example, first logic 320 may be configured to identify an unassigned order in the set of orders. In another example, first logic 320 may be configured to identify a load in the set of loads that violates a constraint in the transportation planning model.

System 300 may also include a second logic 330 that is configured to provide data concerning a transportation planning action that may resolve the exception. Resolving the exception may include, for example, changing an order or load so that a constraint, rule, and/or preference is no longer violated. In another example, resolving the exception may include relaxing a constraint and/or accepting a constraint violation in light of an associated penalty cost. In one example, second logic 330 may be configured to provide data concerning a transportation plan cost change attributable to resolving the exception by taking the transportation planning action and/or a transportation plan utility change attributable to resolving the exception by taking the transportation planning action. In another example, second logic 330 may be configured to provide data concerning a constraint that will be violated if the exception is resolved by taking the transportation planning action.

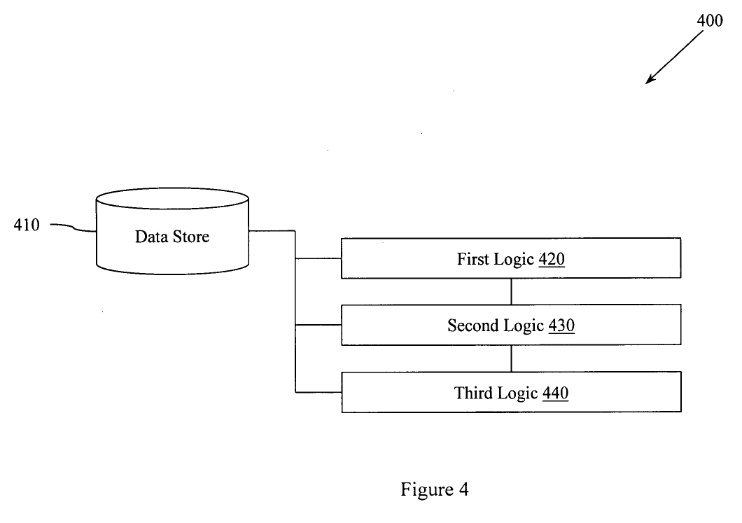

FIG. 4 illustrates an example system 400 that is configured to manipulate a transportation plan. System 400 may include elements 410 through 430 that are similar to elements 310 through 330. System 400 may also include a third logic 440 that is configured to selectively automatically manipulate the transportation plan based, at least in part, on the transportation planning action.

Example planning systems may generate exceptions for a transportation plan. The exceptions may identify problem situations that a planner may consider correcting to improve plan quality. Thus, third logic 440 may be configured to not violate hard constraints that would lead to an exception condition when determining how to manipulate the transportation plan. However, third logic 440 may be configured to violate soft constraints when determining how to manipulate the transportation plan when the benefits of violating the constraint exceed penalty costs associated with violating the constraint. Additionally, some exceptions may be generated when a planner manually adjusts the plan and in so doing violates a constraint.

Thus, system 400 may provide a planner with an opportunity to take a corrective action and resolve exceptions. In some examples, exceptions may be organized into groups that can be collectively turned on/off and/or collectively handled. Example groups may include early/late exceptions, load and order exceptions, carrier exceptions, timing exceptions, cost exceptions, vehicle related exceptions, facility related exceptions, and so on.

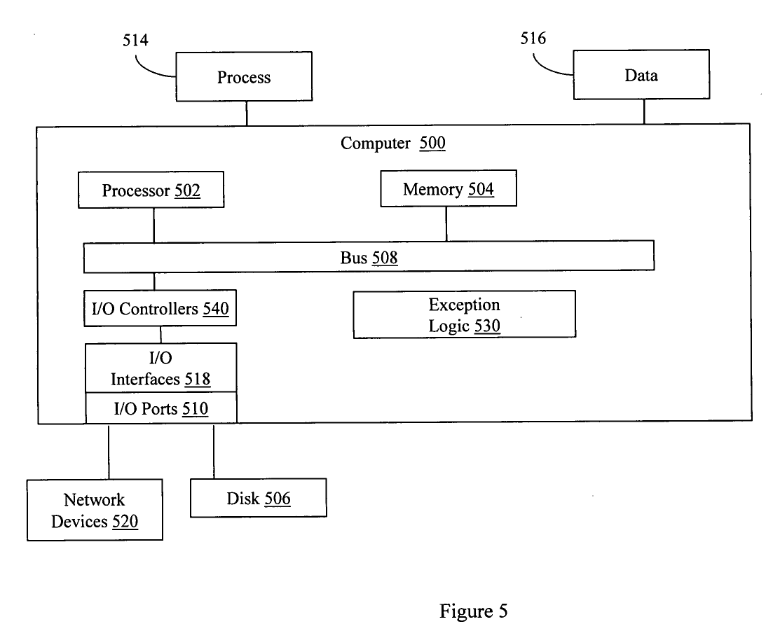

FIG. 5 illustrates an example computing device in which example systems and methods described herein, and equivalents, can operate. The example computing device may be a computer 500 that includes a processor 502, a memory 504, and input/output ports 510 operably connected by a bus 508. In one example, the computer 500 may include an exception logic 530 that is configured to facilitate resolving transportation planning exceptions. Exception logic 530 may implement portions of example systems described herein and may execute portions of example methods described herein. Thus, whether implemented in hardware, software, firmware, and/or combinations thereof, exception logic 530 and computer 500 may provide means for identifying an exception in a transportation plan and means for automatically providing a solution for resolving the exception. While exception logic 530 is illustrated as a separate logic, in one example, copies of exception logic 530 may be stored on disk 506 and/or in memory 504.

Generally describing an example configuration of computer 500, processor 502 can be a variety of various processors including dual microprocessor and other multi-processor architectures. Memory 504 can include volatile memory and/or non-volatile memory. Disk 506 may be operably connected to computer 500 via, for example, an input/output interface (e.g., card, device) 518 and an input/output port 510. Disk 506 can include, but is not limited to, devices like a magnetic disk drive, a solid state disk drive, a floppy disk drive, a tape drive, a Zip drive, a flash memory card, and/or a memory stick. Furthermore, disk 506 can include optical drives like a CD-ROM, a CD recordable drive (CD-R drive), a CD rewriteable drive (CD-RW drive), and/or a digital video ROM drive (DVD ROM). The memory 504 can store processes 514 and/or data 516, for example. Disk 506 and/or memory 504 can store an operating system that controls and allocates resources of computer 500.

Bus 508 can be a single internal bus interconnect architecture and/or other bus or mesh architectures. While a single bus is illustrated, it is to be appreciated that computer 500 may communicate with various devices, logics, and peripherals using other busses that are not illustrated (e.g., PCIE, SATA, Infiniband, 1394, USB, Ethernet).

Computer 500 may interact with input/output devices via i/o interfaces 518 and input/output ports 510. Input/output devices can include, but are not limited to, a keyboard, a microphone, a pointing and selection device, cameras, video cards, displays, disk 506, network devices 520, and the like. Input/output ports 510 can include but are not limited to, serial ports, parallel ports, and USB ports.

Computer 500 can operate in a network environment and thus may be connected to network devices 520 via i/o devices 518, and/or i/o ports 510. Through network devices 520, computer 500 may interact with a network. Through the network, computer 500 may be logically connected to remote computers. The networks with which computer 500 may interact include, but are not limited to, a local area network (LAN), a wide area network (WAN), and other networks. Network devices 520 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, network devices 520 can connect to WAN technologies including, but not limited to, point to point links, circuit switching networks like integrated services digital networks (ISDN), packet switching networks, and digital subscriber lines (DSL).

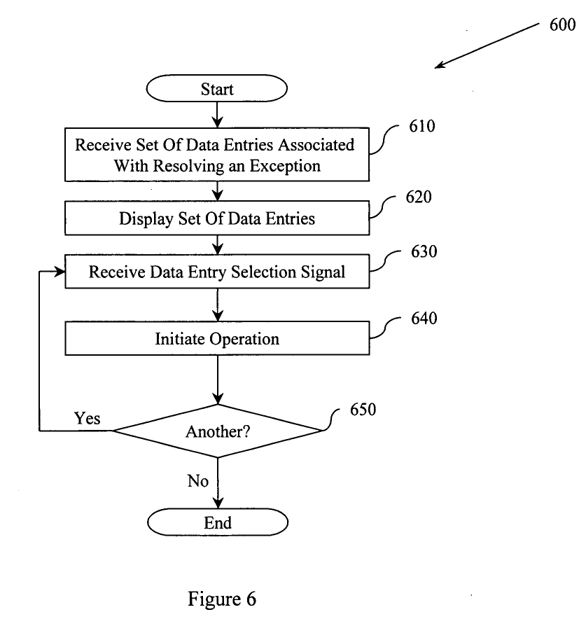

FIG. 6 illustrates an example method 600 that is associated with an example graphical user interface used in transportation planning systems and methods that rely on system-assisted resolution to planning exceptions. Method 600 may be performed by a system that includes a display and a selection device (e.g., mouse, keyboard). Method 600 may facilitate providing and selecting from a set of data entries on the display. Method 600 may include, for example, at 610, retrieving a set of data entries that represent actions associated with manipulating a transportation plan based on an automatically generated planning action configured to resolve an exception. Method 600 may also include, at 620, displaying the set of data entries on the display, at 630, receiving a data entry selection signal indicative of the selection device selecting a selected data entry, and in response to the data entry selection signal, at 640, initiating an operation associated with the selected data entry. Actions initiated at 640 may include, for example, adding a load to the transportation plan, changing a load in the transportation plan, assigning an order to a load, relaxing a constraint for an order, and the like.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modem Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A computer-implemented method for manipulating a transportation plan, comprising:
accessing a set of transportation orders;
accessing an actionable plan of loads;
identifying a planning exception related to the transportation plan;
automatically identifying a candidate planning action for resolving the planning exception;
providing a first data concerning an impact on the transportation plan associated with resolving the planning exception using the candidate planning action;
providing a second data concerning a constraint that would be violated if the planning exception is resolved using the candidate planning action; and
selectively updating the actionable plan of loads based, at least in part, on the candidate planning action, the first data, and the second data.

2. The method of claim 1, where a transportation order includes one or more of, a commodity identifying data, an amount data, a request date data, an earliest acceptable date data, a latest acceptable date data, a scheduled ship date data, a scheduled arrival date data, and a promised delivery date data.

3. The method of claim 1, where a load is described by data that includes one or more of, a route data, a mode data, a carrier data, a service data, a schedule data, and a vehicle data.

4. The method of claim 1, where identifying a planning exception includes identifying one or more of, an unassigned order, and a load that violates a constraint.

5. The method of claim 4, where the constraint concerns a carrier load rule, a carrier rule, a compatibility rule, a ship set rule, an arrival set rule, a carrier service dimension rule, a late delivery rule, an early delivery rule, a late pick-up rule, an early pick-up rule, an effective vehicle capacity rule, a carrier standing appointment rule, a facility receiving calendar rule, a facility receiving hour of operation rule, a facility shipping calendar rule, a facility shipping hour of operation rule, a carrier commitment rule, a vehicle availability rule, a facility dock availability rule, or a facility handling capacity rule.

6. The method of claim 5, where the constraint is configurable with respect to a penalty cost.

7. The method of claim 1, where identifying a candidate planning action includes identifying one or more data items that may be changed to resolve the exception, the one or more data items including an amount data, a scheduled ship date data, a scheduled arrival date data, a route data, a mode data, a carrier data, a service data, or a vehicle data.

8. The method of claim 7, where identifying a candidate planning action includes determining a constraint to violate based, at least in part, on an order in which constraints are to be violated.

9. The method of claim 1, where the first data identifies a transportation plan cost change attributable to resolving the planning exception using the candidate planning action.

10. The method of claim 1, where the first data identifies a transportation plan utility change attributable to resolving the planning exception using the candidate planning action.

11. The method of claim 1, where the candidate planning action is automatically taken to manipulate the actionable plan of loads upon determining that the candidate planning action will reduce the cost of the transportation plan.

12. The method of claim 1, where the candidate planning action is taken to manipulate the actionable plan of loads upon receiving a user input.

13. A computer-readable medium storing computer-executable instructions operable to perform the method of claim 1.

14. A computer-implemented method, comprising:
accessing a set of transportation orders, where a transportation order includes one or more of, a commodity identifying data, an amount data, a request date data, an earliest acceptable date data, a latest acceptable date data, a scheduled ship date data, a scheduled arrival date data, and a promised delivery date data;
accessing an actionable plan of loads, where a load includes one or more of, a route data, a mode data, a carrier data, a service data, a schedule data, and a vehicle data;
identifying a planning exception related to the transportation plan, where identifying a planning exception includes identifying one or more of, an unassigned order, and a load that violates a constraint, where the constraint concerns one or more of, a carrier load rule, a carrier rule, a compatibility rule, a ship set rule, an arrival set rule, a carrier service dimension rule, a late delivery rule, an early delivery rule, a late pick-up rule, an early pick-up rule, an effective vehicle capacity rule, a carrier standing appointment rule, a facility receiving calendar rule, a facility receiving hour of operation rule, a facility shipping calendar rule, a facility shipping hour of operation rule, a carrier commitment rule, a vehicle availability rule, a facility dock availability rule, and a facility handling capacity rule;
automatically identifying a candidate planning action for resolving the planning exception, where identifying a candidate planning action includes identifying one or more of, an amount data, a scheduled ship date data, a scheduled arrival date data, a route data, a mode data, a carrier data, a service data, and a vehicle data to change to resolve the exception, and where the constraint is configurable with respect to one or more of, a threshold level, a major violation level, a minor violation level, and a penalty cost;
providing a first data concerning an impact on the transportation plan associated with resolving the planning exception using the candidate planning action, where the first data identifies one or more of, a change in cost attributable to resolving the planning exception using the candidate planning action, and a change in utility attributable to resolving the planning exception using the candidate planning action;
providing a second data concerning a constraint that would be violated if the planning exception is resolved using the candidate planning action; and
selectively updating the actionable plan of loads based, at least in part, on the candidate planning action, the first data, and the second data, where the candidate planning action is automatically taken to manipulate the actionable plan of loads upon determining that the candidate planning action will reduce the cost of the transportation plan.

15. A computer-based system configured to manipulate a transportation plan, comprising:
a data store configured to store data concerning one or more of, a transportation planning model, a transportation plan, and a set of orders, where the transportation plan includes data concerning a set of loads;
a first logic configured to identify a planning exception related to an order in the set of orders or related to a load in the set of loads; and
a second logic configured to provide data concerning a transportation planning action configured to resolve the exception.

16. The system of claim 15, where the transportation planning model includes data concerning one or more transportation planning constraints.

17. The system of claim 16, the first logic being configured to identify an unassigned order in the set of orders.

18. The system of claim 16, the first logic being configured to identify a load in the set of loads that violates a constraint in the transportation planning model.

19. The system of claim 16, the second logic being configured to provide data concerning one or more of, a transportation plan cost change attributable to resolving the exception by taking the transportation planning action, and a transportation plan utility change attributable to resolving the exception by taking the transportation planning action.

20. The system of claim 19, the second logic being configured to provide data concerning a constraint that will be violated if the exception is resolved by taking the transportation planning action.

21. The system of claim 16, including a third logic configured to selectively automatically manipulate the transportation plan based, at least in part, on the transportation planning action.

22. The system of claim 15, including a third logic configured to selectively automatically manipulate the transportation plan based, at least in part, on the transportation planning action;
the first logic being configured to identify one or more of, an unassigned order in the set of orders, and a load in the set of loads that violates a constraint in the transportation planning model;
the second logic being configured to provide data concerning one or more of, a transportation plan cost change attributable to resolving the exception by taking the transportation planning action, and a transportation plan utility change attributable to resolving the exception by taking the transportation planning action;
the second logic being configured to provide data concerning a constraint that will be violated if the exception is resolved by taking the transportation planning action; and
where the transportation planning model includes data concerning one or more transportation planning constraints.

23. A system, comprising:
means for identifying an exception in a transportation plan; and
means for automatically providing a solution for resolving the exception.

24. In a computer system having a graphical user interface comprising a display and a selection device, a method of providing and selecting from a set of data entries on the display, the method comprising:
retrieving a set of data entries, where a data entry represents an action associated with manipulating a transportation plan based on an automatically generated planning action configured to resolve an exception;
displaying the set of data entries on the display;
receiving a data entry selection signal indicative of the selection device selecting a selected data entry; and
in response to the data entry selection signal, initiating an operation associated with the selected data entry.

25. A computer-implemented method for producing a computer-assisted resolution to a transportation planning exception, comprising:
generating a transportation plan;
identifying an exception in the transportation plan; and
resolving the exception by manipulating the transportation plan.
